(19) United States
(12) Patent Application Publication
(10) Pub. No.: US 2019/0247990 A1
(43) Pub. Date: Aug. 15, 2019

(54) MUFFLING STRUCTURE FOR PNEUMATIC TOOL

(71) Applicant: STORM PNEUMATIC TOOL CO., LTD., Taichung City (TW)

(72) Inventor: Yung Yung Sun, Taichung City (TW)

(21) Appl. No.: 15/896,373

(22) Filed: Feb. 14, 2018

(51) Int. Cl. B25D 17/12; B23B 45/04; F01N 1/08

(52) U.S. Cl. CPC B25D 17/12; F01N 1/085; B23B 45/04

(57) ABSTRACT

A muffling structure for a pneumatic tool is provided and disposed in an exhaust pipe of the pneumatic tool. The muffling structure includes: an outer cylinder separated from the exhaust pipe by an outer gap-channel and defined with inlet and outlet ends, with the outlet end having a stop portion; an inner cylinder defined with an upstream end and a downstream end, the downstream end passing the inlet end to protrude into the outer cylinder and abut against the stop portion. The upstream end protrudes from the inlet end and has a baffling plate. The baffling plate has an area not less than the inlet end and separates from the exhaust pipe by a gap. An inner gap-channel is formed between the inner and outer cylinders. A communication opening whereby the outer and inner gap-channels are in communication is formed between the baffling plate and the inlet end.

### BACKGROUND OF THE INVENTION

### 1. Technical Field

The present invention relates to pneumatic tools and, more particularly, to a muffling structure for a pneumatic tool.

### 2. Description of Related Art

A pneumatic tool is driven by compressed gas introduced into the pneumatic tool. However, it produces enormous noise while discharging gas. The noise thus produced is a nuisance to the users and even a health hazard. Hence, a pneumatic tool usually comes with a muffler for noise reduction.

A conventional muffler is filled with a sound-absorbing material composed of nonwoven fabric or cotton. Owing to its porosity, the sound-absorbing material permits passage of gas flow while producing a small degree of resistance thereto to slow down the gas flow, thereby effectuating noise reduction. However, suspended particles (including dust and ash) and impurities (including moisture and oil vapor) present in the surroundings in which pneumatic tools operate are admitted to the pneumatic tools together with the incoming gas flow and clog the pores of the sound-absorbing material, thereby obstructing the gas flow in the pneumatic tools. As a result, the pneumatic tools become inefficient and even inoperable.

### BRIEF SUMMARY OF THE INVENTION

In view of the aforesaid drawbacks of the prior art, it is an objective of the present invention to provide a muffling structure for a pneumatic tool, characterized by an exhaust passage comprising at least two conduits, so as to reduce exhaust-induced noise.

Another objective of the present invention is to replace a conventional sound-absorbing material with the muffling structure whereby the pneumatic tool produces less noise but not at the expense of efficiency.

In order to achieve the above and other objectives, the present invention provides a muffling structure for a pneumatic tool, with the muffling structure disposed in an exhaust pipe of the pneumatic tool, the muffling structure comprising:

an outer cylinder extending along the exhaust pipe and spaced apart from the exhaust pipe by an outer gap channel, wherein an inlet end and an outlet end are defined at the outer cylinder, the outlet end having a stop portion; and

an inner cylinder extending along the exhaust pipe and defined with an upstream end and a downstream end, the downstream end passing the inlet end to protrude into the outer cylinder and abut against the stop portion, whereas the upstream end protruding from the inlet end and having a baffling plate extending laterally, the baffling plate having an area greater than or equal to that of the inlet end and being spaced apart from the exhaust pipe by a gap, wherein an inner gap channel is formed between the inner cylinder and the outer cylinder, and a communication opening whereby the outer gap channel and the inner gap channel are in communication is formed between the baffling plate and the inlet end.

In an embodiment, a front bump is disposed at the baffling plate of the inner cylinder to abut against a front positioning portion of the exhaust pipe, and a rear bump is disposed at the outlet end of the outer cylinder to abut against a rear positioning portion of the exhaust pipe.

In an embodiment, the inner cylinder encloses a middle channel, and the baffling plate has a through gap opening in communication with the middle channel.

In an embodiment, the outer cylinder and the inner cylinder are each slender and oblongly cylindrical or cylindrical.

### BRIEF DESCRIPTION OF THE DRAWINGS

FIG. 1 is a schematic view of a muffling structure according to the first embodiment of the present invention and a corresponding pneumatic tool which the muffling structure is disposed in;

FIG. 2 is a perspective, exploded view of the muffling structure according to the first embodiment of the present invention;

FIG. 3 is a cross-sectional view of the muffling structure according to the first embodiment of the present invention, showing how the muffling structure operates;

FIG. 4 is a schematic view of the muffling structure according to the second embodiment of the present invention and a corresponding pneumatic tool which the muffling structure is disposed in;

FIG. 5 is a perspective, exploded view of the muffling structure according to the second embodiment of the present invention; and

FIG. 6 is a cross-sectional view of the muffling structure according to the second embodiment of the present invention, showing how the muffling structure operates.

### DETAILED DESCRIPTION OF THE EMBODIMENTS OF THE INVENTION

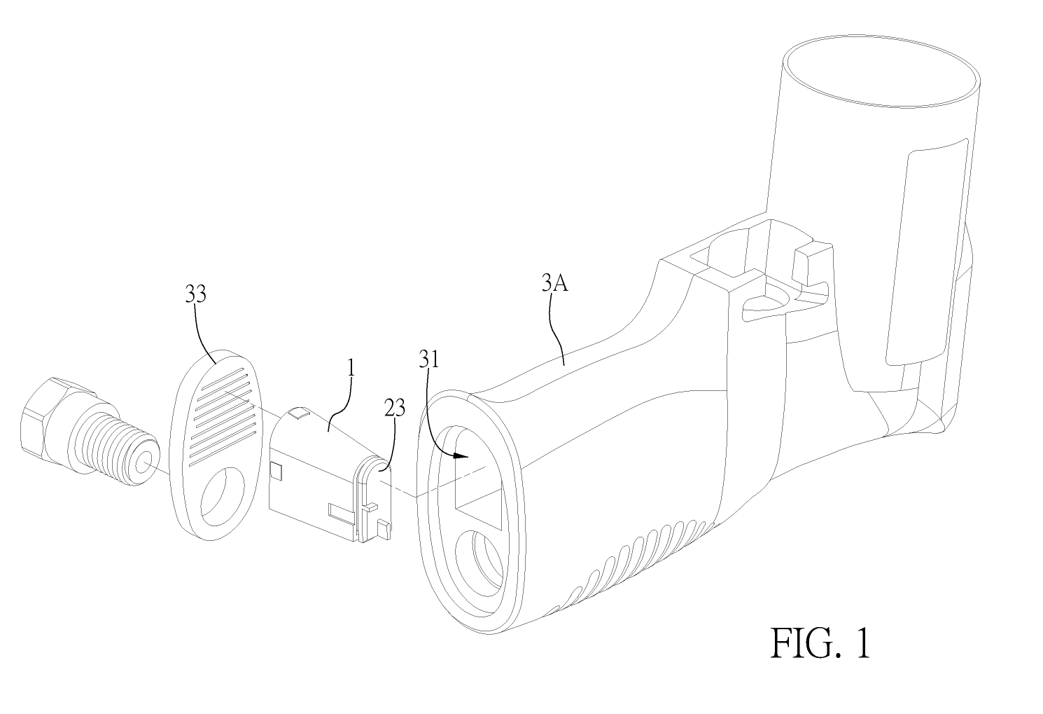

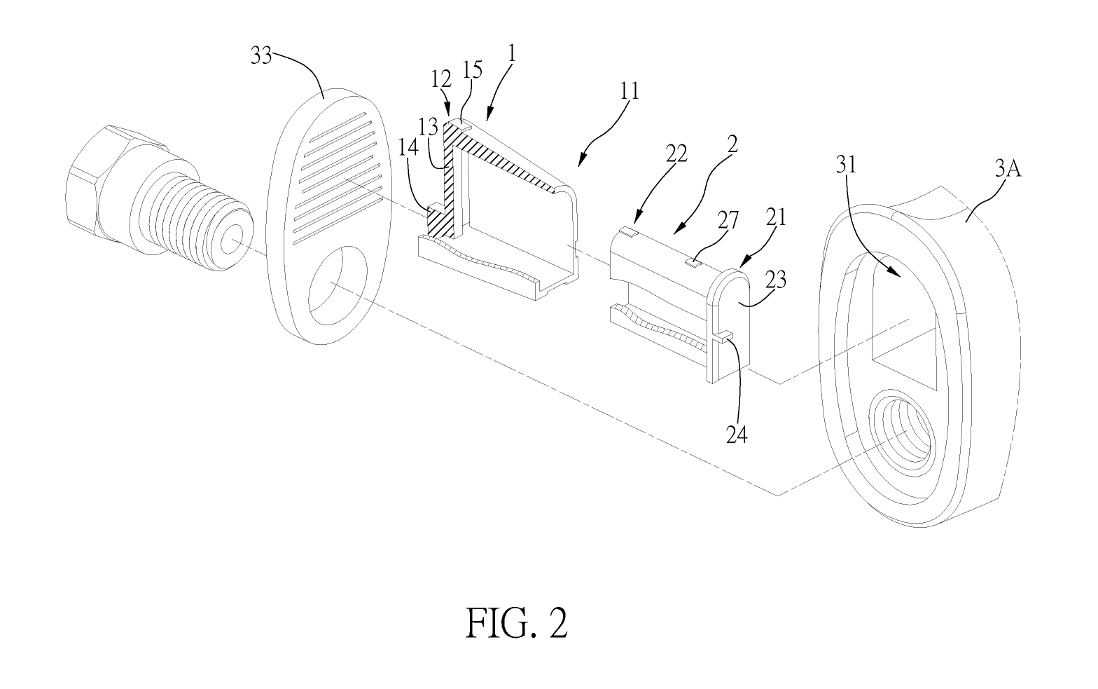

Referring to FIG. 1 through FIG. 3, there are shown diagrams of a muffling structure for a pneumatic tool according to the first embodiment of the present invention. As shown in the diagrams, the muffling structure is disposed in an exhaust pipe 31 of a pneumatic tool 3A. A front positioning portion 32 and a rear positioning portion 33 are disposed in the exhaust pipe 31 and adapted to position the muffling structure in place. The muffling structure comprises an outer cylinder 1 and an inner cylinder 2 which the outer cylinder 1 fits around. The outer cylinder 1 and the inner cylinder 2 each correspond in shape to the exhaust pipe 31 and thus are each slender and oblongly cylindrical.

The outer cylinder 1 extends along the exhaust pipe 31 and has a smaller outer diameter than the exhaust pipe 31. A plurality of positioning bumps 15 is disposed on the outer wall of the outer cylinder 1 to abut against the inner wall of the exhaust pipe 31 and thereby effectuate the positioning of the outer cylinder 1 relative to the exhaust pipe 31. Owing to the plurality of positioning bumps 15, an outer gap channel 41 is formed between the outer cylinder 1 and the exhaust pipe 31. Depending on the direction of gas flow, an inlet end 11 and an outlet end 12 are defined at the outer cylinder 1. The outlet end 12 of the outer cylinder 1 has a stop portion 13. In this embodiment, the stop portion 13 is a rib extending laterally without closing the outlet end 12. A rear bump 14 is disposed at the outlet end 12 of the outer cylinder 1 to abut against the rear positioning portion 33 of the exhaust pipe 31 to not only effectuate the positioning of the outer cylinder 1 relative to the exhaust pipe 31 but also space apart the outer cylinder 1 and the rear positioning portion 33.

The inner cylinder 2 also extends along the exhaust pipe 31. Depending on the direction of gas flow, an upstream end 21 and a downstream end 22 are defined at the inner cylinder 2. The inner cylinder 2 has a smaller outer diameter than the outer cylinder 1. The downstream end 22 of the inner cylinder 2 passes the inlet end 11 to protrude into the outer cylinder 1 and abut against the stop portion 13 without protruding from the outlet end 12. A plurality of positioning bumps 27 is disposed on the outer wall of the inner cylinder 2 to abut against the inner wall of the outer cylinder 1, so as to not only effectuate the positioning of the inner cylinder 2 relative to the outer cylinder 1 but also allow an inner gap channel 42 to be formed between the inner cylinder 2 and the outer cylinder 1. The inner cylinder 2 is of a greater length than the outer cylinder 1 such that the upstream end 21 protrudes from the inlet end 11. The upstream end 21 has a baffling plate 23. The baffling plate 23 extends laterally to take up most of the cross-sectional area of the exhaust pipe 31. The area of the baffling plate 23 is greater than or equal to that of the inlet end 11 of the outer cylinder 1. The edge of the baffling plate 23 and the exhaust pipe 31 are spaced apart by a gap 43 which the gas flow passes through. Since the upstream end 21 of the inner cylinder 2 protrudes from the inlet end 11 of the outer cylinder 1, a communication opening 44 whereby the outer gap channel 41 and the inner gap channel 42 are in communication is formed between the baffling plate 23 and the inlet end 11.

A front bump 24 is disposed at the edge of the baffling plate 23 of the inner cylinder 2 to abut against the front positioning portion 32 of the exhaust pipe 31. Owing to the front bump 24, not only is the inner cylinder 2 fixed to the front positioning portion 32, but space for gas flow is also created above the baffling plate 23.

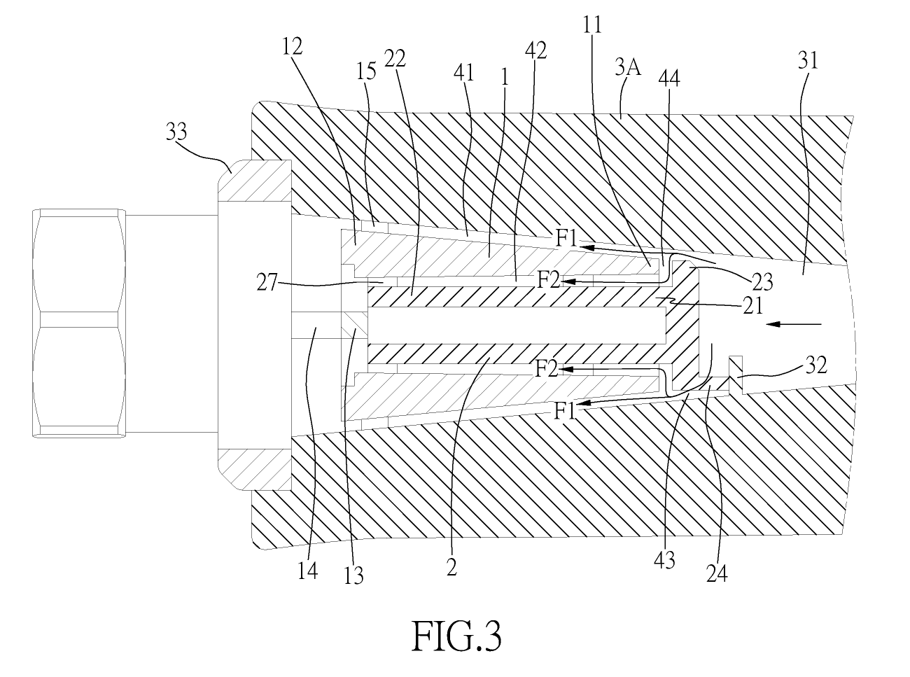

Given the aforesaid structural features, as soon as a driving gas of the pneumatic tool 3A is discharged from the exhaust pipe 31, the gas flow is restrained by the baffling plate 23 as shown in FIG. 3 and passes the muffling structure through the gap 43 at the edge of the baffling plate 23. Afterward, the gas flow divides into two currents: a current F1 and a current F2. The current F1 flows along the outer gap channel 41 and passes through the outer cylinder 1. The current F2 passes through the communication opening 44 and then enters the inner gap channel 42 before exiting the outlet end 12 of the outer cylinder 1. During the aforesaid process, after being restrained by the baffling plate 23, the gas flow becomes turbulent and thus slows down, thereby entering the outer gap channel 41 and the inner gap channel 42 at a low speed. With the two gap channels 41, 42 being narrow, the speed of the gas flow is further reduced, so as to reduce exhaust-induced noise. Related tests show that the present invention dispenses with a conventional sound-absorbing material and still equals or even surpasses the conventional sound-absorbing material in muffling efficiency. Furthermore, by dispensing with the conventional sound-absorbing material, the present invention is advantageous in that impurities in the gas flow are unlikely to clog a gas passage, allowing the gas to be discharged from the pneumatic tool 3A smoothly and thus protecting the pneumatic tool 3A against damage.

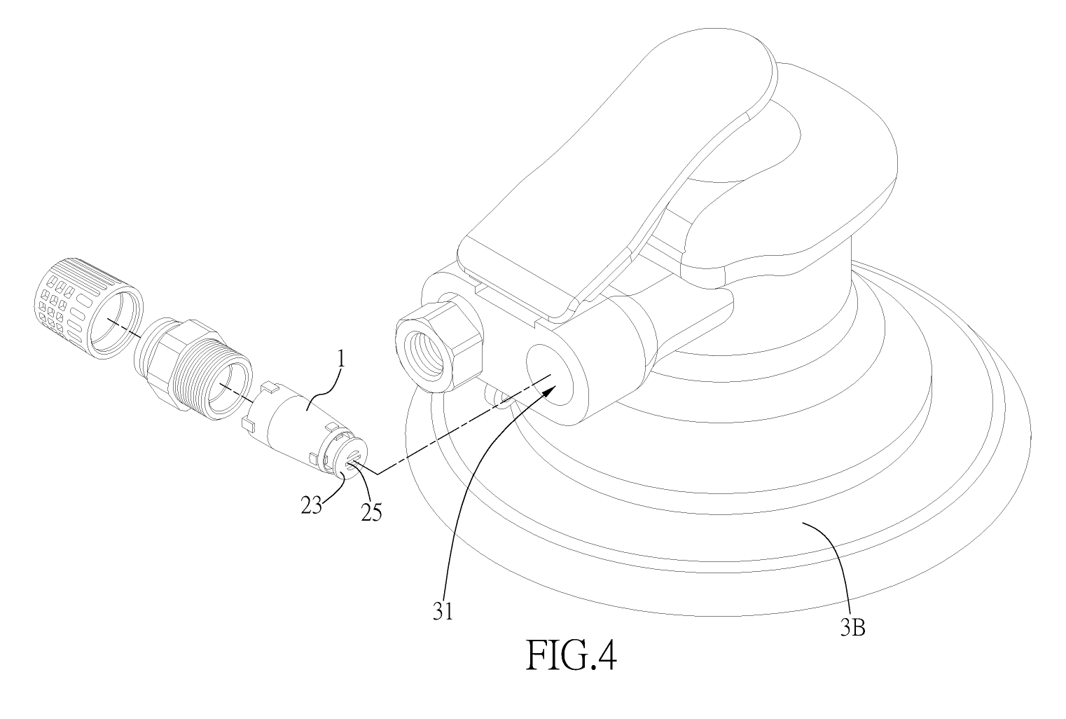

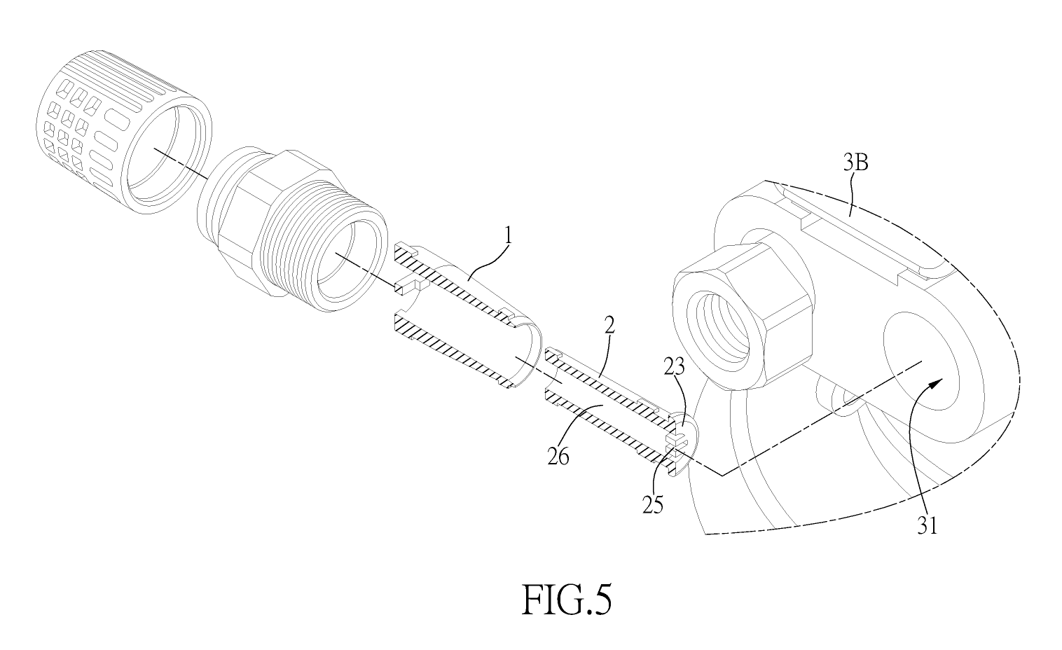

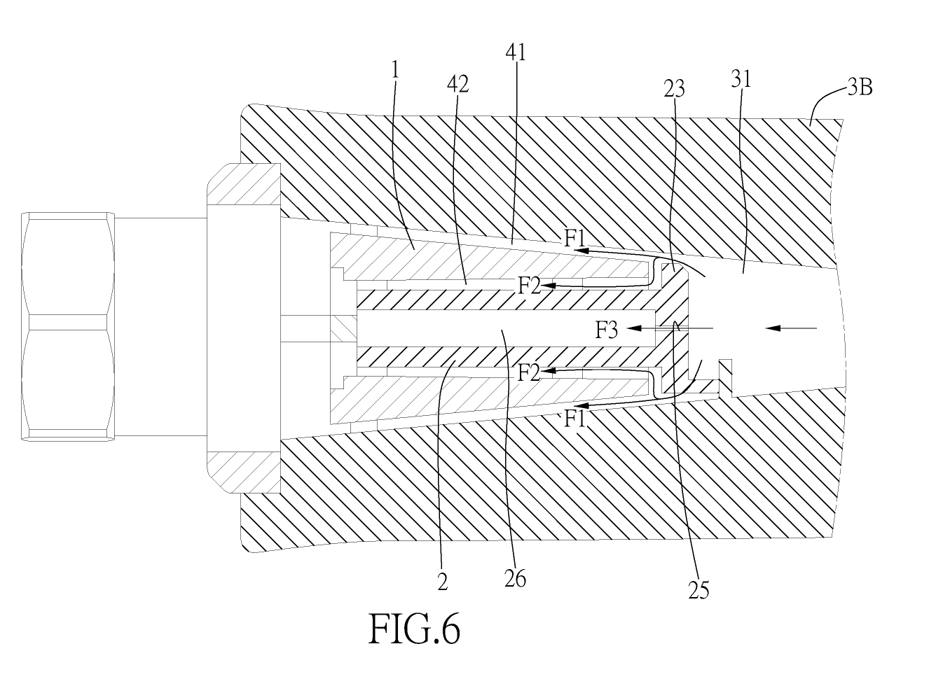

FIGS. 4, 5 illustrate the muffling structure according to the second embodiment of the present invention. The outer cylinder 1 and the inner cylinder 2 of the muffling structure in the second embodiment of the present invention each correspond in shape to the exhaust pipe 31 of a pneumatic tool 3B (which is of a different type from the pneumatic tool 3A) and thus are each cylindrical. In the second embodiment, the baffling plate 23 has a through gap opening 25, and the inner cylinder 2 encloses a middle channel 26 which the gap opening 25 is in communication with. Referring to FIG. 6, in the second embodiment, the gas flow divides into three currents: the currents F1, F2 and a current F3. The currents F1, F2 enter the outer gap channel 41 and the inner gap channel 42. The current F3 passes through the gap opening 25 to enter the middle channel 26 and thus reduce the pressure and speed of the gas flow further, thereby achieving optimal noise reduction.

What is claimed is:

1. A muffling structure for a pneumatic tool, with the muffling structure disposed in an exhaust pipe of the pneumatic tool, the muffling structure comprising:
an outer cylinder extending along the exhaust pipe and spaced apart from the exhaust pipe by an outer gap channel, wherein an inlet end and an outlet end are defined at the outer cylinder, the outlet end having a stop portion; and
an inner cylinder extending along the exhaust pipe and defined with an upstream end and a downstream end, the downstream end passing the inlet end to protrude into the outer cylinder and abut against the stop portion, whereas the upstream end protruding from the inlet end and having a baffling plate extending laterally, the baffling plate having an area greater than or equal to that of the inlet end and being spaced apart from the exhaust pipe by a gap, wherein an inner gap channel is formed between the inner cylinder and the outer cylinder, and a communication opening whereby the outer gap channel and the inner gap channel are in communication is formed between the baffling plate and the inlet end.

2. The muffling structure for a pneumatic tool according to claim 1, wherein a front bump is disposed at the baffling plate of the inner cylinder to abut against a front positioning portion of the exhaust pipe, and a rear bump is disposed at the outlet end of the outer cylinder to abut against a rear positioning portion of the exhaust pipe.

3. The muffling structure for a pneumatic tool according to claim 1, wherein the inner cylinder encloses a middle channel, and the baffling plate has a through gap opening in communication with the middle channel.
